(19) United States
(12) Patent Application Publication
(10) Pub. No.: US 2015/0127548 A1
(43) Pub. Date: May 7, 2015

(54) METHOD AND SYSTEM FOR GENERATING ONE-TO-ONE MERCHANT OFFERS

(71) Applicant: MasterCard International Incorporated, Purchase, NY (US)

(72) Inventor: Rohit CHAUHAN, Somers, NY (US)

(73) Assignee: MasterCard International Incorporated, Purchase, NY (US)

(21) Appl. No.: 14/069,579

(22) Filed: Nov. 1, 2013

(51) Int. Cl. G06Q 30/02; G06Q 20/38

(52) U.S. Cl. CPC G06Q 30/0225; G06Q 20/3829
USPC 705/71

(57) ABSTRACT

A method for discounting a payment transaction includes: storing, in a memory, transaction data for a payment transaction, wherein the transaction data includes at least a transaction amount; receiving, by a receiving device, payment data submitted for payment for the payment transaction, wherein the payment data includes at least a consumer identifier corresponding to a consumer and payment information; receiving, by the receiving device, offer data, wherein the offer data includes an offer identifier corresponding to the consumer and a transaction modifier; encrypting, using a predetermined encryption key, the consumer identifier to obtain an encrypted consumer identifier; and updating, in the memory, the transaction amount included in the transaction data based on the transaction modifier if the encrypted consumer identifier corresponds to the offer identifier.

### FIELD

The present disclosure relates to the discounting of a payment transaction, specifically the generating of an offer to be used exclusively by a single consumer and the redemption thereof at a point of sale using encrypted payment data.

### BACKGROUND

Offers, such as coupons, deals, discounts, rewards, etc., are often used by merchants, manufacturers, retailers, and other entities to increase consumer business. Merchants may hope to gain return customers who redeem an offer at their store, or may hope that customers shop at their store to redeem an offer and then buy additional products that recoup any potential loss of profits from the offer. Manufacturers may hope to gain a loyal customer who will provide repeat business following the purchase of a product using an offer.

While it may generally be of interest for a merchant or manufacturer to gain as large of a customer base as possible, the wide distribution of offers may require significant resources and carry a large expense. As a result, offers are often distributed to particular groups of consumers considered to be more likely to redeem an offer and/or return to the store or product afterwards, identified using targeting techniques, such as based on consumer demographics and/or transaction data. To this end, merchants and manufacturers, and/or offer distributers working on behalf or to the advantage of the merchants and manufacturers, may spend considerable time and resources to identify ideal consumers for the receipt of offers.

However, in many instances, offers distributed to consumers are not exclusive to the consumer. In such instances, the specifically-targeted consumer may pass the offer on to a different consumer that it outside of the merchant or manufacturer's target market. This may result in a consumer that is unlikely to be a repeat customer redeeming an offer, which may financially hurt the merchant in cases where a merchant may accept a loss for redemption of an offer in the hope of eventual returns through repeat business.

In an effort to provide offers that are exclusive to specific consumers, some merchants have begun to provide offers to consumers via loyalty programs. In such programs, the merchant may associate offers with a specific consumer, which may then be redeemed by only that consumer after providing proof of their loyalty account. However, such a system requires consumers to previously register with the merchant to obtain a loyalty account, and thus is inadequate for providing offers to first-time consumers. In addition, such systems are ineffective for manufacturers who wish to provide offers to consumers for redemption and multiple merchants. In order to provide consumer-exclusive offers to consumers that may be redeemed at multiple merchants, some manufacturers have begun providing offers where each distributed offer has a unique identifier or redemption code. However, such offers may still be susceptible to being passed to other consumers as there are no controls on redemption.

Thus, there is a need for a technical solution for the generating and distribution thereof of offers that are exclusive to specific consumers that may be redeemed exclusively by the consumer at multiple merchants without relying on a closed loop system.

### SUMMARY

The present disclosure provides a description of systems and methods for the discounting of payment transactions and distribution of offer data.

A method for discounting a payment transaction includes: storing, in a memory, transaction data for a payment transaction, wherein the transaction data includes at least a transaction amount; receiving, by a receiving device, payment data submitted for payment for the payment transaction, wherein the payment data includes at least a consumer identifier corresponding to a consumer and payment information; receiving, by the receiving device, offer data, wherein the offer data includes an offer identifier corresponding to the consumer and a transaction modifier; encrypting, using a predetermined encryption key, the consumer identifier to obtain an encrypted consumer identifier; and updating, in the memory, the transaction amount included in the transaction data based on the transaction modifier if the encrypted consumer identifier corresponds to the offer identifier.

A method for distributing offer data includes: storing, in a database, a plurality of offer data entries, wherein each offer data entry includes data related to an offer for the purchase of goods or services including at least offer data and a transaction modifier; receiving, by a receiving device, a consumer identifier associated with a consumer; encrypting, using a predetermined encryption key, the received consumer identifier to obtain an encrypted identifier; identifying, in the database, a specific offer data entry; and transmitting, by a transmitting device, at least the encrypted identifier and the offer data and transaction modifier included in the specific offer data entry to the consumer.

A system for discounting a payment transaction includes a memory, a receiving device, and a processing device. The memory is configured to store transaction data for a payment transaction, wherein the transaction data includes at least a transaction amount. The receiving device is configured to: receive payment data submitted for payment for the payment transaction, wherein the payment data includes at least a consumer identifier corresponding to a consumer and payment information; and receive offer data, wherein the offer data includes an offer identifier corresponding to the consumer and a transaction modifier. The processing device is configured to: encrypt, using a predetermined encryption key, the consumer identifier to obtain an encrypted consumer identifier; and update, in the memory, the transaction amount included in the transaction data based on the transaction modifier if the encrypted consumer identifier corresponds to the offer identifier.

A system for distributing offer data includes a database, a receiving device, a processing device, and a transmitting device. The database is configured to store a plurality of offer data entries, wherein each offer data entry includes data related to an offer for the purchase of goods or services including at least offer data and a transaction modifier. The receiving device is configured to receive a consumer identifier associated with a consumer. The processing device is configured to: encrypt, using a predetermined encryption key, the received consumer identifier to obtain an encrypted identifier; and identify, in the database, a specific offer data entry. The transmitting device is configured to transmit at least the encrypted identifier and the offer data and transaction modifier included in the specific offer data entry to the consumer.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for the distribution of offer data and discounting of a payment transaction based thereon in accordance with exemplary embodiments.

FIG. 2 is a block diagram illustrating the point of sale of FIG. 1 for the discounting of a payment transaction using a consumer-exclusive offer in accordance with exemplary embodiments.

FIG. 3 is a flow diagram illustrating a process for the generating of a personalized consumer offer for distribution thereof in accordance with exemplary embodiments.

FIG. 4 is a flow diagram illustrating a process for the identification of a consumer-exclusive offer and use thereof to discount a payment transaction in accordance with exemplary embodiments.

FIG. 5 is a flow diagram illustrating a method for the generating and distribution of an offer exclusive to a consumer and the redemption thereof at a point of sale using the system of FIG. 1 in accordance with exemplary embodiments.

FIG. 6 is a flow chart illustrating a method for the identification of a consumer-exclusive offer and processing thereof to discount a payment transaction by the point of sale of FIG. 2 in accordance with exemplary embodiments.

FIG. 7 is a flow chart illustrating an exemplary method for discounting a payment transaction in accordance with exemplary embodiments.

FIG. 8 is a flow chart illustrating an exemplary method for distributing offer data in accordance with exemplary embodiments.

FIG. 9 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Definition of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Account—A financial account that may be used to fund a transaction, such as a checking account, savings account, credit account, virtual payment account, etc. A payment account may be associated with an entity, which may include a person, family, company, corporation, governmental entity, etc. In some instances, a payment account may be virtual, such as those accounts operated by PayPal®, etc.

Payment Card—A card or data associated with a payment account that may be provided to a merchant in order to fund a financial transaction via the associated payment account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant, or may be data representing the associated payment account (e.g., as stored in a communication device, such as a smart phone or computer). For example, in some instances, data including a payment account number may be considered a payment card for the processing of a transaction funded by the associated payment account. In some instances, a check may be considered a payment card where applicable.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require and special knowledge in offered products. In some embodiments, an entity involved in a single transaction may be considered a merchant.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card.

Acquirer—An entity that may process payment card transactions on behalf of a merchant. The acquirer may be a bank or other financial institution authorized to process payment card transactions on a merchant's behalf. In many instances, the acquirer may open a line of credit with the merchant acting as a beneficiary. The acquirer may exchange funds with an issuer in instances where a consumer, which may be a beneficiary to a line of credit offered by the issuer, transacts via a payment card with a merchant that is represented by the acquirer.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

### System for the Distribution and Redemption of Consumer-Exclusive Offers

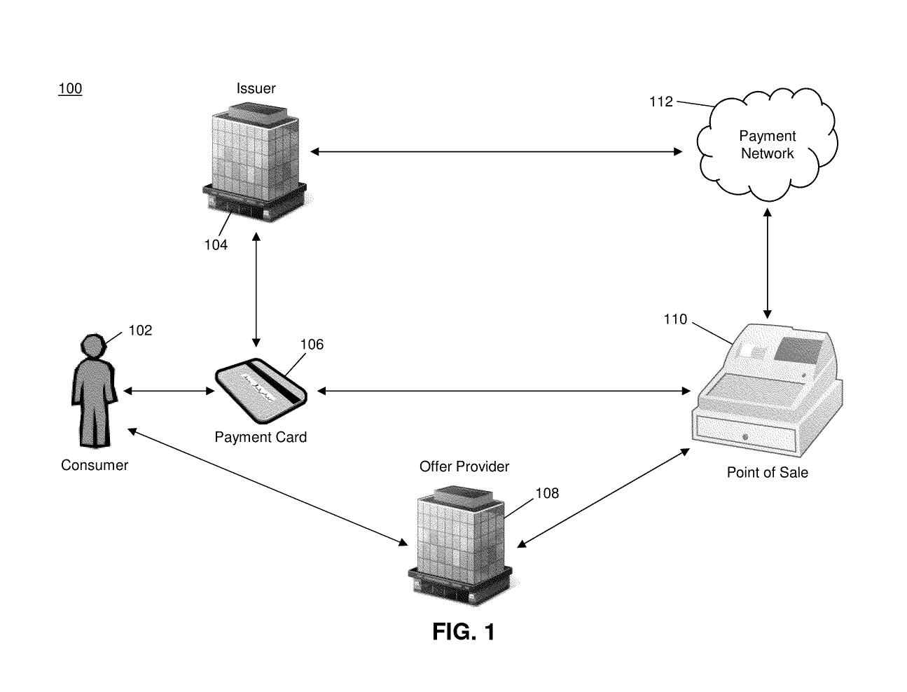

FIG. 1 illustrates a system 100 for the generation and distribution of consumer-exclusive offers and the redemption thereof at a point of sale.

The system 100 may include a consumer 102. The consumer 102 may have one or more payment accounts opened with an issuer 104, such as an issuing bank. The issuer 104 may issue a payment card 106 to the consumer 102 associated with a payment account opened by the consumer 102 with the issuer 104. The payment card 106 may be encoded with payment data associated with the payment account and/or the consumer 102. For example, the payment card may be encoded with an account number or account identifier associated with the payment account, a name of the consumer 102, an e-mail address, a phone number, or other information unique to the consumer 102 and/or the payment account.

The system 100 may also include an offer provider 108. The offer provider 108 may be a merchant, manufacturer, retailer, third party offer provider, or other suitable entity configured to generate offers exclusive to a consumer using the systems and methods as disclosed herein. As discussed in more detail below, the offer provider 108 may generate an encrypted identifier for an offer using an encryption key and one or more pieces of consumer data encoded in the payment card 106 as provided by the consumer 102. For example, the offer provider 108 may generate an identifier by encrypting the name of the consumer 102 using an encryption key.

The offer provider 108 may then generate a machine-readable code that is encoded with the encrypted offer identifier and additional offer data. The additional offer data may include an offer name, offer description, offer amount, transaction modifier, start date, end date, quantity, limitations on redemption, and other suitable data that will be apparent to persons having skill in the relevant art. The offer provider 108 may then distribute the offer including at least the generated machine-readable code to the consumer 102. Methods for distributing offer data to a consumer will be apparent to persons having skill in the relevant art and may include e-mail, short message service message, multimedia service message, a webpage, an application program, etc.

The consumer 102 may then initiate a payment transaction at a merchant point of sale 110 for the purchase of one or more products (e.g., goods and/or services). As part of the payment transaction, the consumer 102 may present the payment card 106 to the point of sale 110. The point of sale 110 may read the payment and consumer data encoded on the payment card 106 and decode the read data to obtain the payment and consumer data. The consumer 102 may also present the personalized offer to the point of sale 110. The point of sale 110 may read the machine-readable code associated with the offer to obtain and then decode the encoded offer data and encrypted identifier.

The offer provider 108 may transmit the encryption key used to obtain the encrypted identifier, or a second encryption key associated with the encryption key used to obtain the encrypted identifier, to the point of sale 110. In some instances, the offer provider 108 may transmit the encryption key to the point of sale 110 prior to the initiating of the payment transaction by the consumer 102. In other instances, the point of sale 110 may request the encryption key from the offer provider 108 when presented with the personalized offer. In some embodiments, an encryption key pair may be used such that the offer provider 108 uses a first key of the pair to encrypt the identifier, and the point of sale 110 may use a second key of the pair, as discussed in more detail below, to encrypt and/or decrypt data to validate the authenticity of the offer and the consumer 102.

The point of sale 110 may identify a consumer identifier included in the decoded personal data read from the payment card 106. The consumer identifier may be an item of personal data unique to the consumer 102 and encoded in the payment card 106, such as a name, e-mail address, phone number, or physical address. The point of sale 110 may encrypt the consumer identifier using the encryption key received from the offer provider 108. The point of sale 110 may then validate the offer presented by the consumer 102 by comparing the encrypted consumer identifier with the encrypted identifier read and decoded from the offer. If the validation is successful, the point of sale 110 may apply the offer to the transaction using the offer data via systems and methods that will be apparent to persons having skill in the relevant art.

The point of sale 110 may then submit the transaction data for the payment transaction to an acquirer (not shown), which may then generate and submit an authorization request for the payment transaction to a payment network 112. In some embodiments, the point of sale 110 may generate the authorization request, which may then be transmitted to the payment network 112 directly or via the acquirer. The payment network 112 may then process the discounted payment transaction using conventional methods and systems that will be apparent to persons having skill in the relevant art.

By encrypting personal data encoded on the payment card 106 for generating the identifier to be used for the personalized offer, the offer may be redeemed at any point of sale 110 configured to perform the functions disclosed herein. As such, an offer may be provided by a manufacturer (e.g., as or via the offer provider 108) to the consumer 102 for redemption at a plurality of different merchants. In addition, by using personal data to generate the encrypted identifier rather than payment data specific to a payment account or payment card 106, the consumer 102 may redeem the offer using any payment card or alternative payment method where the personal data is conveyed. In addition, by using the personal data of the consumer 102, the offer may not be easily passed on to another consumer, and thus not redeemed by someone outside of the target market for a merchant or manufacturer.

### Point of Sale Device

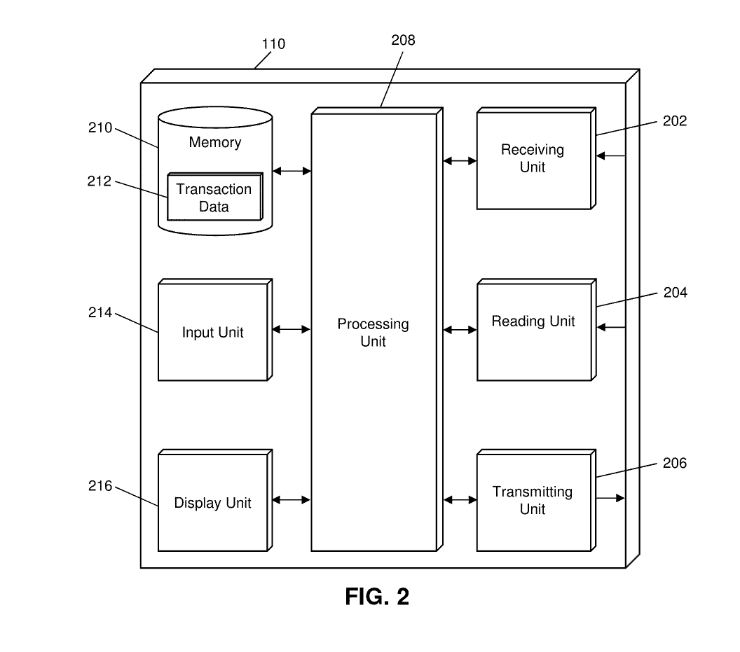

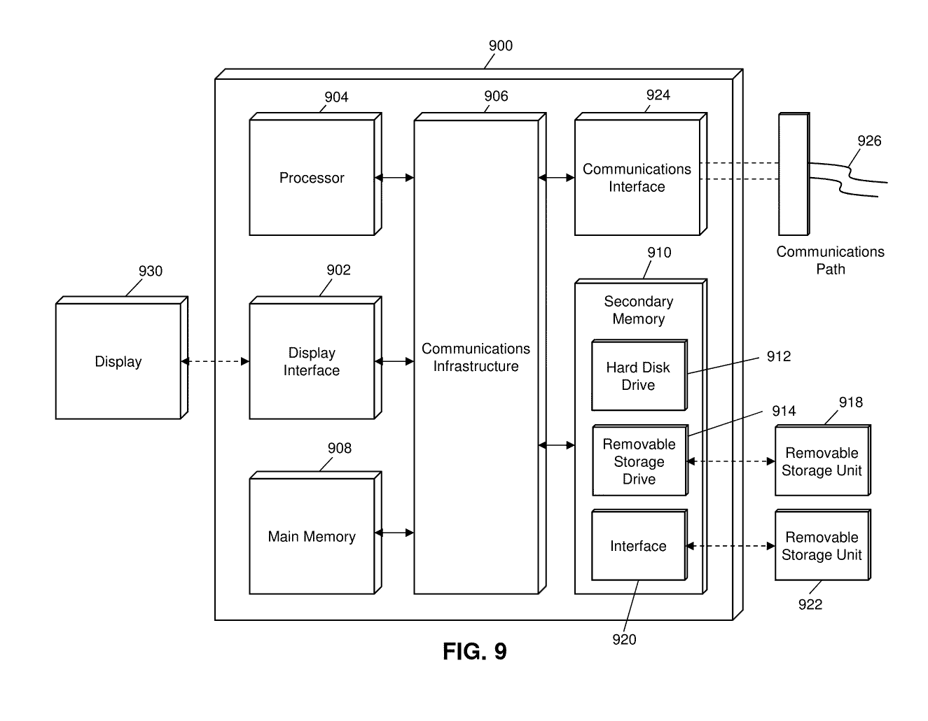

FIG. 2 illustrates an embodiment of the point of sale 110 of the system 100. It will be apparent to persons having skill in the relevant art that the embodiment of the point of sale 110 illustrated in FIG. 2 is provided as illustration only and may not be exhaustive to all possible configurations of the point of sale 110 suitable for performing the functions as discussed herein. For example, the computer system 900 illustrated in FIG. 9 and discussed in more detail below may be a suitable configuration of the point of sale 110.

The point of sale 110 may include a receiving unit 202. The receiving unit 202 may be configured to receive data over one or more networks via one or more network protocols. The point of sale 110 may receive an encryption key from the offer provider 108 for use in encrypting consumer data for the validation of personalized offers as discussed herein. The point of sale 110 may also include a processing unit 208, which may be configured to store the received encryption key in a memory 210.

The point of sale 110 may further include one or more reading units 204. Each reading unit 204 may be configured to read encoded data using methods that will be apparent to persons having skill in the relevant art. The reading unit 204 may read product data for one or more products to be purchased by the consumer 102 as part of a payment transaction. The processing unit 208 may then store corresponding data (e.g., purchase amounts, quantity, etc.) as transaction data 212 in the memory 210. Methods and systems for generating transaction data based on read product data will be apparent to persons having skill in the relevant art.

The point of sale 110 may further include an input unit 214. The input unit 214 may be a keyboard, mouse, click wheel, touch screen, microphone, camera, or other suitable type of device for receiving input as will be apparent to persons having skill in the relevant art. In some instances, a user of the point of sale 110 may use the input unit 214 to enter product or transaction data and/or instruct the reading unit 204 to read product data from one or more products to be purchased. The point of sale 110 may also include a display unit 216. The display unit 216 may be configured to display the transaction data 212 and any other relevant information to a user. The display unit 216 may be any type of suitable display device, such as a liquid crystal display, light emitting diode display, cathode ray tube display, capacitive touch display, light projection display, etc.

The point of sale 110 may also include a reading unit 204 configured to read payment and consumer data encoded in a payment card 106. Methods for reading data encoded in a payment card will be apparent to persons having skill in the relevant art, and include magnetic strip swipe readers, Near Field Communication (NFC) readers, optical code readers, to name a few. The processing unit 208 may identify and decode the encoded data to obtain the payment and consumer data. The processing unit 208 may then identify a consumer identifier included in the consumer data and encrypt the consumer identifier using the encryption key received and stored in the memory 210 to obtain an encrypted consumer identifier.

The reading unit 204, or a separate reading unit (not illustrated), may be configured to read offer data and an encrypted identifier encoded in a machine-readable code presented by the consumer 102 associated with an offer to be redeemed. The processing unit 208 may then decode the offer data and encrypted identifier. The processing unit 208 may compare the encrypted identifier encoded in the personalized offer with the encrypted consumer identifier. If the identifiers match, then the personalized offer may be validated as being presented by the consumer 102 to which the offer was distributed. The processing unit 208 may then modify the transaction data 212 based on the offer data using methods and systems that will be apparent to persons having skill in the relevant art for discounting a transaction based on offer data.

If the identifiers do not match, the display unit 216 may display a notification for the user and/or the consumer 102 indicating the failed validation of the personalized offer. The consumer 102 and/or user may then retry the validation, such as by presenting the payment card 106 or alternative payment data and re-presenting the personalized offer, which depending on the content of the encrypted identifier, might be suggested by a display the display unit 216. In some embodiments, the processing unit 208 may encrypt the identifier read and decoded from the personalized offer prior to comparison with the encrypted consumer identifier. In such an embodiment, the identifier included in the personalized offer may be unencrypted when read and decoded from the machine-readable code associated with the offer.

After the offer has been applied and the payment transaction discounting, a transmitting unit 206 in the point of sale 110 may be configured to transmit the transaction data 212 to an acquirer over one or more networks via one or more network protocols. In one embodiment, the processing unit 208 may first generate an authorization request for the payment transaction including the transaction data 212, which may then be transmitted by the transmitting unit 206 to the acquirer. In some instances, the transmitting unit 206 may be configured to transmit the authorization request directly to the payment network 112.

After the transaction has been processed by the payment network 112, the receiving unit 202 may receive an authorization response indicating approval or denial of the transaction. The display unit 216 may display the response to the user and/or the consumer 102 indicating the approval or denial of the transaction, which the merchant and consumer 102 may respond to accordingly to finalize the payment transaction. In some embodiments, the transmitting unit 206 may transmit a notification to the consumer 102, offer provider 108, and/or other suitable entity indicating the successful redemption of the personalized offer.

### Process for Generating a Personalized Offer

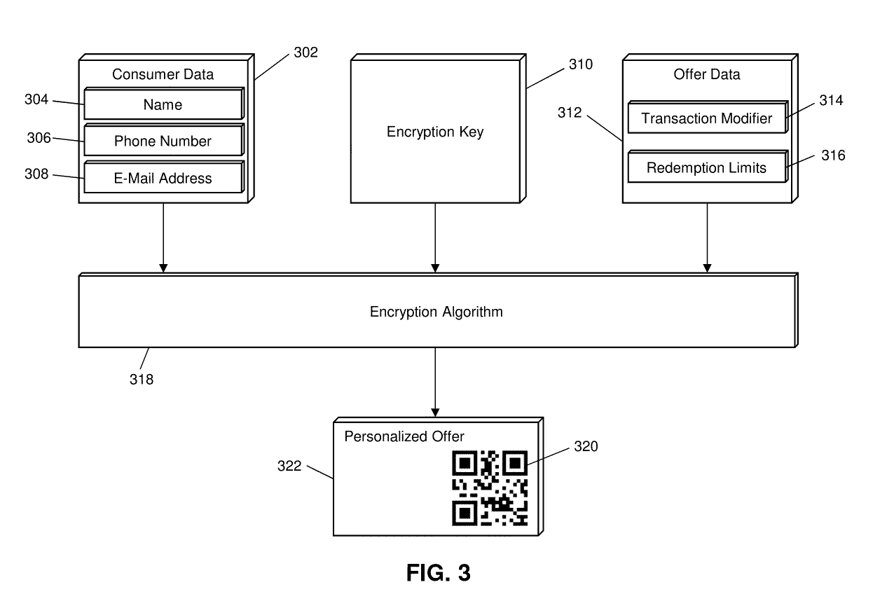

FIG. 3 illustrates a process for the generating of a personalized offer using encrypted consumer data. The process illustrated in FIG. 3 and discussed herein may be executed by a processing device, such as the point of sale 110, the computer system 900 of FIG. 9, or other suitable processing device as will be apparent to persons having skill in the relevant art. For example, the offer provider 108 may include a computer system, such as the computer system 900 of FIG. 9, which may be configured to execute the process of FIG. 3 to generate a personalized offer as discussed herein.

As illustrated in FIG. 3, the generation of a personalized offer may utilize consumer data 302, an encryption key 310, and offer data 312. The consumer data 302 may include data associated with a consumer 102 to whom the personalized offer is to be associated. The consumer data 302 may include a name 304, a phone number 306, an e-mail address 308, and/or any other suitable data that may be unique to the associated consumer 102 or otherwise used to identify the consumer 102 for validation of the personalized offer. In an exemplary embodiment, the consumer data 302 may be data associated with the consumer 102 that may be encoded in a plurality of payment cards 106 issued to the consumer 102. In some instances, only a single item (e.g., the name 304) of the consumer data 302 may be used. In other instances, multiple items of consumer data 302 may be used, such as if the name 304 of the consumer 102 is a common name or the phone number 306 is used by multiple consumers (e.g., members of the same household).

The encryption key 310 may be any suitable type of encryption key used for encrypting the consumer data 302 as will be apparent to persons having skill in the relevant art. In some embodiments, the encryption key 310 may be associated with the merchant or point of sale 110 with whom the personalized offer is to be redeemed. In a further embodiment, the encryption key 310 may be unique to a specific merchant. In some instances, the encryption key 310 may be one key of an encryption key pair. In such an instance, the corresponding encryption key may be transmitted to the point of sale 110 for use in validating the personalized offer.

The offer data 312 may include data regarding the personalized offer to be applied to the transaction data 212 by the point of sale 110 to discount the offer, and/or to the displayed to the consumer 102 (e.g., on or accompanying the personalized offer) indicating information regarding the personalized offer. The offer data 312 may include at least a transaction modifier 314 and redemption limits 316. The transaction modifier 314 may be a condition, amount, algorithm, etc. for application to the transaction data 212 for discounting of the payment transaction upon validation of the personalized offer. The redemption limits 316 may be one or more limits or conditions for redemption of the offer, such as a start date, end date, offer quantity, minimum transaction amount, etc. Additional data that may be included in the offer data 312 will be apparent to persons having skill in the relevant art.

The encryption key 310 may be applied to the consumer data 302 and offer data 312 via an encryption algorithm 318. The encryption algorithm 318 may be configured to encrypt, using the encryption key 310, at least the consumer data 302 (e.g., the name 304) to obtain an encrypted identifier. In some embodiments, the encryption algorithm 318 may also encrypt the offer data 312 with the encryption key 310. In other embodiments, the encryption algorithm 318 may combine the unencrypted offer data 312 with the encrypted consumer data 302 to obtain a single set of data for the personalized offer.

The processing of the encryption algorithm 318 may yield the personalized offer 322. The personalized offer 322 may include a generated machine-readable code 320, such as a bar code or a QR code. The machine-readable code 320 may be encoded with the output of the encryption algorithm 318, which may include the encrypted consumer data 302 and the offer data 312. The encrypted consumer data 302 and the offer data 312 may be combined into a single set of data encoded in the machine-readable code 320 or may be encoded in the machine-readable code 320 as two separate sets of data (e.g., as indicated by a separator) using methods and systems that will be apparent to persons having skill in the relevant art.

The personalized offer 322 may then be distributed to the consumer 102 associated with the consumer data 302 used to generate the offer. The consumer 102 may then present the personalized offer 322 at the point of sale 110, where the point of sale 110 may read the machine-readable code 320 and process the data, using methods and systems discussed herein, to validate the consumer 102 as authorized to redeem the personalized offer 322. In some embodiments, the personalized offer 322 may include offer data 312 viewable by the consumer 102, such as to identify the offer (e.g., an offer name or offer description) and/or terms of the offer (e.g., the offer amount, offer type, expiration date, etc.).

### Process for Discounting a Transaction Using the Personalized Offer

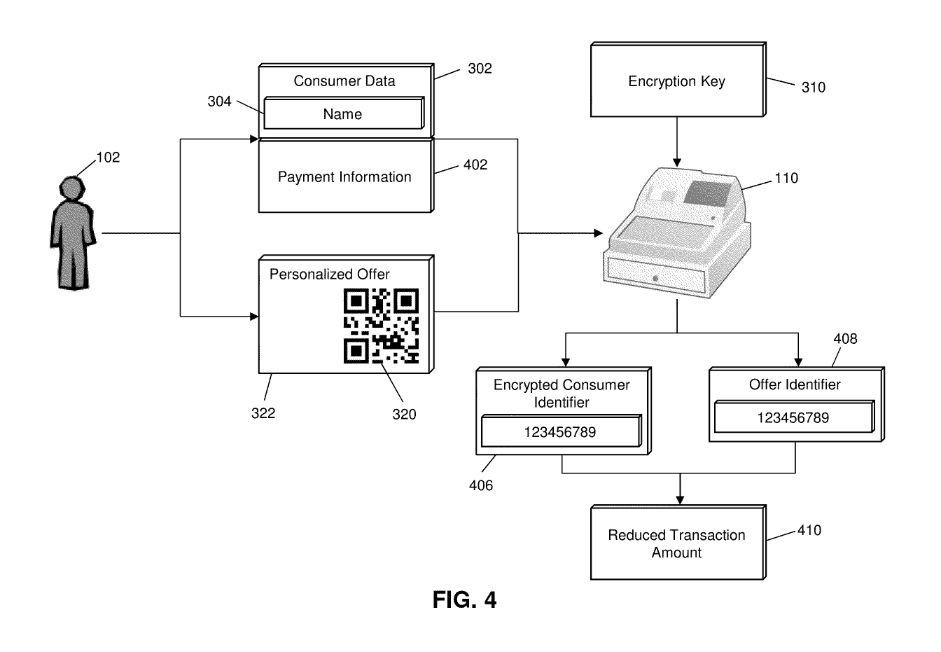

FIG. 4 illustrates a process for the presentation and processing of the personalized offer generated using the process of FIG. 3.

The consumer 102 may visit a merchant and initiate a payment transaction. As part of the payment transaction, the consumer 102 may present the payment card 106 for payment to the point of sale 110. The point of sale 110 may read consumer data 302 and payment information 402 encoded in the payment card 106. The consumer data 302 may include at least a name 304 used to generate the personalized offer 322, as discussed above with respect to the process of FIG. 3.

The consumer 102 may also present the personalized offer 322 to the point of sale 110. The point of sale 110 may read the machine-readable code 320 to obtain the offer data 312 and an encrypted consumer identifier 406 encoded therein. Prior to, or during, the processing of the payment transaction, the point of sale 110 may also receive the encryption key 310 used to generate the encrypted consumer identifier 406 decoded from the machine-readable code 320 (e.g., or a key corresponding to the encryption key 310).

The point of sale 110 may then encrypt the name 304 included in the consumer data 302 to obtain an encrypted consumer identifier 406. In some embodiments, the machine-readable code 320 may be encoded with an unencrypted identifier. In such an embodiment, the point of sale 110 may encrypt the unencrypted identifier using the encryption key 310 or a second encryption key to obtain the offer identifier 408.

The point of sale 110 may then compare the encrypted consumer identifier 406 to the offer identifier 408 to validate the consumer 102 attempting to redeem the offer. If the two identifiers 406 and 408 are equal, as is illustrated in FIG. 4, then the processing unit 208 of the point of sale 110 may apply the offer data 312 (e.g., including the transaction modifier 314) encoded in the machine-readable code 320 to the transaction data 212 to obtain a reduced transaction amount 410. The payment transaction may then be processed, by the payment network 112, for the reduced transaction amount 410 as a result of the successfully redeemed offer.

### Method for Generating, Distributing, and Process a Personalized Offer

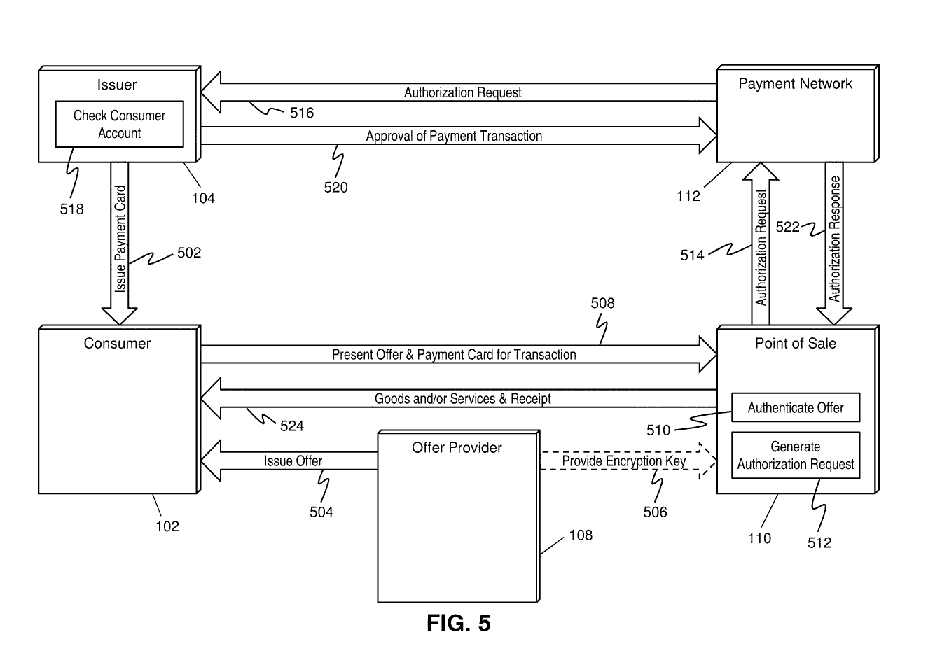

FIG. 5 illustrates a method for the generating and distribution of a personalized offer to the consumer 102 and the processing thereof by the point of sale 110 using the system 100 of FIG. 1.

In step 502, the issuer 104 may issue the payment card 106 to the consumer 102. The payment card 106 may be encoded with payment information 402 and consumer data 302. The consumer data 302 may include at least one consumer identifier, such as a name 304 of the consumer 102. In step 504, the offer provider 108 may distribute a personalized offer 322 to the consumer 102, such as the personalized offer 322 generated using the process illustrated in FIG. 3 and discussed herein. The personalized offer 322 may include a machine-readable code 320 encoded with offer data and an offer identifier 408. In step 506, the offer provider 108 may transmit an encryption key 310 to the point of sale 110 for use in validating the personalized offer 322. It will be apparent to persons having skill in the relevant art that step 506 may be an optional step.

In step 508, the consumer 102 may initiate a payment transaction at the point of sale 110. Initiating the payment transaction may include presenting the payment card 106 and the personalized offer 322 to the point of sale 110. In step 510, the point of sale 110 may authenticate the personalized offer 322. Authentication of the personalized offer 322 may include encrypting the consumer data 302 to obtain an encrypted consumer identifier 406 and comparing the encrypted consumer identifier 406 to the offer identifier 408. Once the offer is authenticated, the processing unit 208 of the point of sale 110 may discount the transaction amount based on the offer data and may generate an authorization request reflected the updated transaction data, in step 512.

In step 514, the point of sale 110 (e.g., or an acquirer associated with the point of sale 110) may transmit the authorization request to the payment network 112 for processing. In step 516, the payment network 112 may forward the authorization request to the issuer 104. In step 518, the issuer 104 may check the payment account used to fund the payment transaction based on the payment information 402 provided by the consumer 102 and included in the authorization request. Checking the payment account may include checking for adequate funds and/or credit to fund the payment transaction based on account information and a transaction amount included in the authorization request.

In step 520, the issuer 104 may transmit an approval of the payment transaction to the payment network 112 indicating the ability for the consumer 102 to pay for the payment transaction. In step 522, the payment network 112 may transmit an authorization response indicating approval of the payment transaction to the point of sale 110. It will be apparent to persons having skill in the relevant art that steps 514 through 522 represent a traditional method for processing a payment transaction and that additional or alternative steps and/or methods may be used to process the payment transaction. In step 524, the merchant associated with the point of sale 110 may provide the purchased goods and/or services to the consumer 102 and/or furnish the consumer 102 with a receipt for the payment transaction.

Method for Processing a Personalized Offer to Discount a Payment Transaction

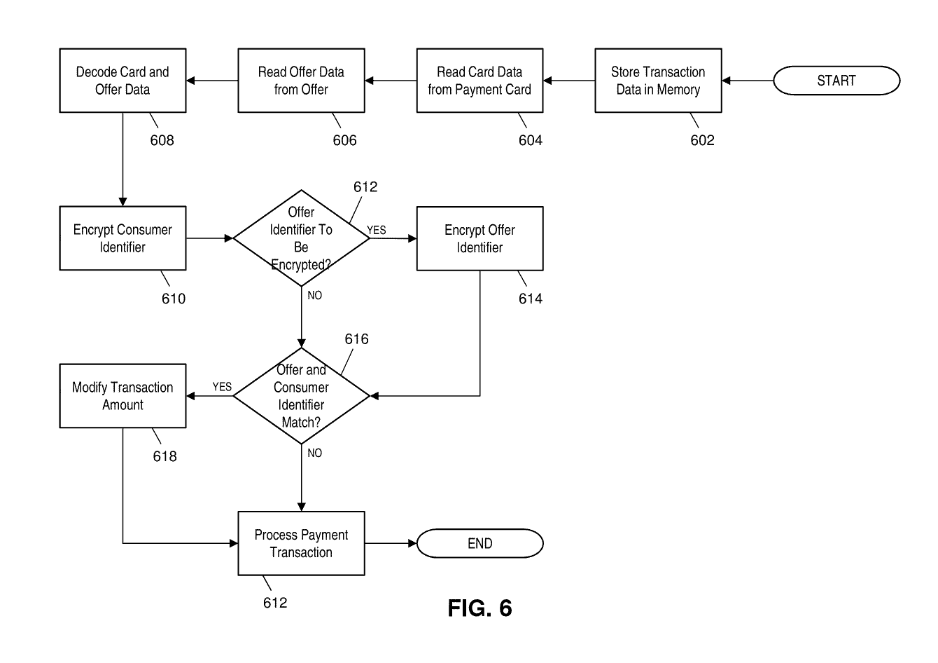

FIG. 6 illustrates a method for processing a personalized offer 322 at the point of sale 110 to discount a payment transaction. In one embodiment, the method illustrated in FIG. 6 may be performed as part of steps 510 and 512 of the process illustrated in FIG. 5.

In step 602, the processing unit 208 of the point of sale 110 may store the transaction data 212 in the memory 210. The transaction data 212 may include a transaction amount, product data (e.g., read by the reading unit 204 and/or input by the input unit 214, etc.), and other relevant data. In step 604, a reading unit 204 of the point of sale 110 may read card data from the payment card 106 presented by the consumer 102. The card data may be encoded in the payment card 106 (e.g., in a magnetic stripe or NFC chip) for reading by the reading unit 204.

In step 606, a reading unit 204 may read offer data encoded in a machine-readable code 320 associated with a personalized offer 322 presented by the consumer 102 to the point of sale 110. In step 608, the processing unit 208 may decode the card data to obtain consumer data 302 and payment information 402 encoded therein. The consumer data 302 may include at least one consumer identifier, such as the name 304. The processing unit 208 may also decide the read offer data to obtain at least a transaction modifier 314 and an offer identifier 408 encoded therein.

In step 610, the processing unit 208 may use an encryption key 310 (e.g., and stored in the memory 210) to encrypt the consumer identifier included in the consumer data 302 to obtain an encrypted consumer identifier 406. In some embodiments, the processing unit 208 may use an encryption key 310 identified based on information included in the offer data. For example, the offer data may include a key identifier, an identifier associated with the offer provider 108, or other suitable information that may be used to identify an encryption key 310 for use in the encryption of the consumer identifier for validation of the personalized offer 322.

In step 612, the processing unit 208 may determine if the identifier included in the offer data needs to be encrypted prior to validation. In some embodiments, the processing unit 208 may determine the need for the identifier included in the offer data to be encrypted based on information included in the offer data and/or programming instructions (e.g., stored in the memory 210). If the identifier is to be encrypted, then, in step 614, the processing unit 208 may encrypt the identifier to obtain the offer identifier 408.

Once the offer identifier 408 has been encrypted, or if the offer identifier 408 does not need to be encrypted, then, in step 616, the processing unit 208 may compare the encrypted consumer identifier 406 with the offer identifier 408 to determine if the consumer 102 is a valid consumer to redeem the personalized offer 322. If the comparison is successful, then, in step 618, the processing unit 208 may modify the transaction amount included in the transaction data 212 based on at least the transaction modifier 314 included in the transaction data. Methods and systems used for discounting a transaction amount based on offer data will be apparent to persons having skill in the relevant art.

Once the transaction data 212 has been modified, or if the consumer 102 is not eligible to redeem the personalized offer 322 (e.g., because of a failed validation and/or violation of redemption limits 316 set to the personalized offer 322), the processing unit 208 may process the payment transaction, in step 612. In one embodiment, processing the payment transaction may include transmitting the transaction data 312 to an acquirer. In another embodiment, processing the payment transaction may include generating an authorization request including the transaction data 212 and the payment information 402. In a further embodiment, the transmitting unit 206 of the point of sale 110 may transmit the generated authorization request to the payment network 112 for processing.

### Exemplary Method for Discounting a Payment Transaction

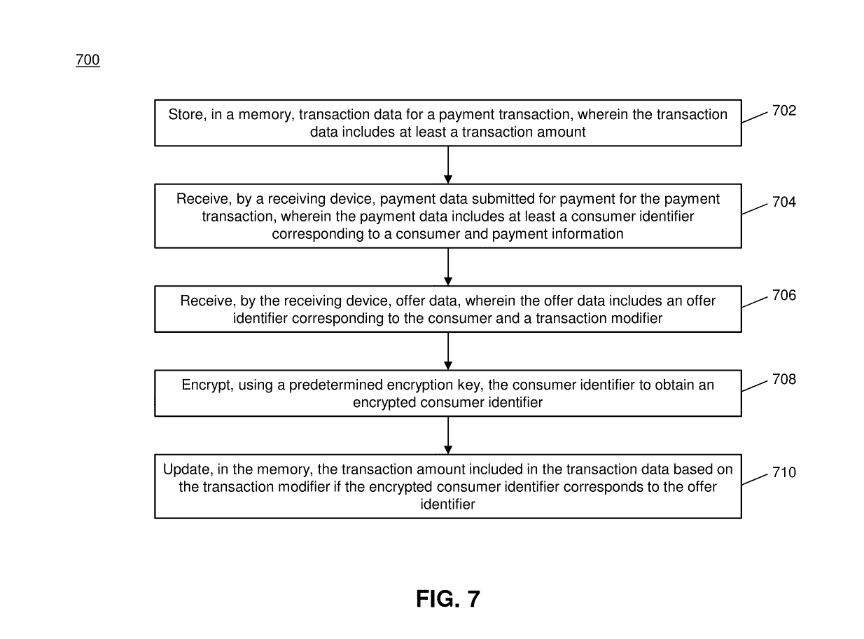

FIG. 7 illustrates a method 700 for the discounting of a payment transaction based on a personalized offer 302.

In step 702, transaction data (e.g., the transaction data 212) for a payment transaction may be stored in a memory (e.g., the memory 210), wherein the transaction data 212 includes at least a transaction amount. In one embodiment, the transaction data 212 may further include at least one of: transaction time and/or date, merchant name, merchant category, device identifier, merchant identifier, and product data.

In step 704, payment data submitted for payment for the payment transaction may be received, by a receiving device (e.g., the receiving unit 202), wherein the payment data includes at least a consumer identifier (e.g., the name 304) corresponding to a consumer (e.g., the consumer 102) and payment information (e.g., the payment information 402). In one embodiment, the consumer identifier may be one of: a name 304, e-mail address (e.g., the e-mail address 308), phone number (e.g., the phone number 306), and physical address.

In step 706, offer data (e.g., the offer data 312) may be received, by the receiving device 202, wherein the offer data 312 includes an offer identifier (e.g., the offer identifier 408) corresponding to the consumer 102 and a transaction modifier (e.g., the transaction modifier 314). In some embodiments, the offer data 312 may further include at least one of: offer name, offer description, offer type, manufacturer data, merchant data, product data, start date, expiration date, quantity, and limitation on redemption.

In one embodiment, receiving the payment data may include reading, by a first reading device (e.g., the reading unit 204), card data encoded on a payment card, and decoding, by a processing device (e.g., the processing unit 208), the read card data to obtain the payment data, and receiving the offer data 312 may include reading, by a second reading device 204, encoded offer data encoded in a machine-readable code (e.g., the machine-readable code 320), and decoding, by the processing device 208, the read encoded offer data to obtain the offer data 312. In a further embodiment, the first reading device 204 and the second reading device 204 may be a single device.

In step 708, the consumer identifier may be encrypted, using a predetermined encryption key (e.g., the encryption key 310), to obtain an encrypted consumer identifier (e.g., the encrypted consumer identifier 406).

In step 710, the transaction amount included in the transaction data 212 may be updated, in the memory 210, based on the transaction modifier 314 if the encrypted consumer identifier 406 corresponds to the offer identifier 408. In one embodiment, the method 700 may further include: encrypting, using one of: the predetermined encryption key 310 or a second key corresponding to the predetermined encryption key, the offer identifier 408 to obtain an encrypted offer identifier, wherein the updating step is performed if the encrypted consumer identifier 406 corresponds to the encrypted offer identifier. In another embodiment, the offer identifier 408 may be an encrypted identifier.

In one embodiment, the method 700 may further include transmitting, by a transmitting device (e.g., the transmitting unit 206), at least the transaction data 212 and the payment information 402 to an acquirer for use in processing the payment transaction. In an alternative embodiment, the method 700 may further include: generating, by the processing device 208, an authorization request for the payment transaction, wherein the authorization request includes at least the transaction data 212 and the payment information 402; and transmitting, by the transmitting device 206, the authorization request to a payment network (e.g., the payment network 112).

### Exemplary Method for Distributing Offer Data

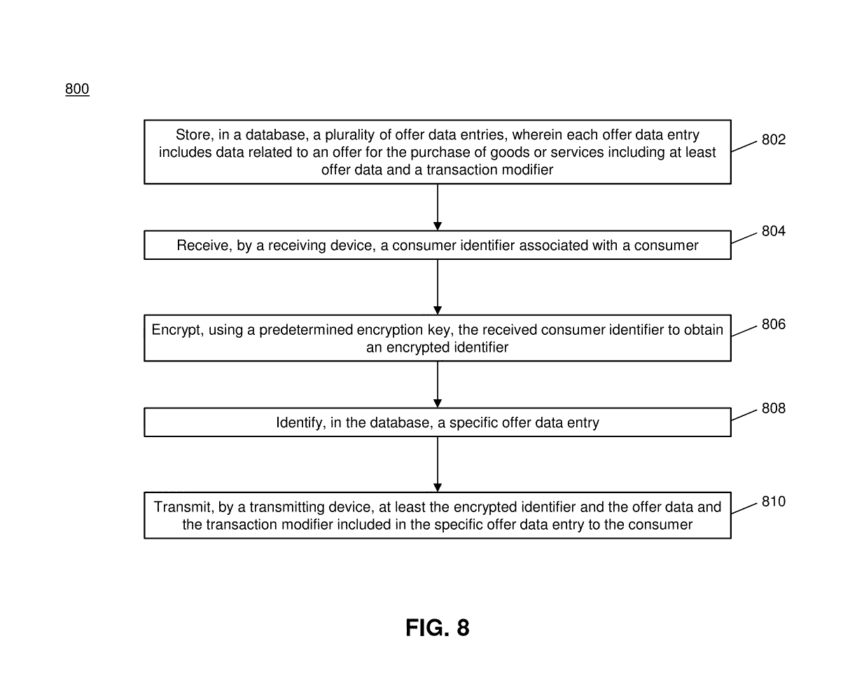

FIG. 8 illustrates a method 800 for distributing offer data for a personalized offer 322 associated with a consumer 102.

In step 802, a plurality of offer data entries may be stored, in a database, wherein each offer data entry may include data related to an offer for the purchase of goods or services including at least offer data (e.g., the offer data 312) and a transaction modifier (e.g., the transaction modifier 314). In one embodiment, the offer data 312 may further include at least one of: offer name, offer description, offer type, manufacturer data, merchant data, product data, start date, expiration date, quantity, and limitation on redemption.

In step 804, a consumer identifier (e.g., the name 304) associated with a consumer (e.g., the consumer 102) may be received, by a receiving device (e.g., the receiving unit 202). In one embodiment, the consumer identifier may be at least one of: a name 304, an e-mail address (e.g., the e-mail address 308), a phone number (e.g., the phone number 306), and a physical address. In step 806, the received consumer identifier 304 may be encrypted, using a predetermined encryption key (e.g., the encryption key 310) to obtain an encrypted identifier (e.g., the offer identifier 408).

In step 808, a specific offer data entry may be identified in the database. In step 810, a transmitting device may transmit at least the encrypted identifier 408 and the offer data 312 and the transaction modifier 314 included in the specific offer data entry to the consumer 102. In one embodiment, the method 800 may further include generating, by a processing device, a machine-readable code (e.g., the machine-readable code 320) encoded with at least the encrypted identifier 408 and the offer data 312 and the transaction modifier 314 included in the specific offer data entry, wherein transmitting at least the encrypted identifier 408 and the offer data 312 and transaction modifier 314 included in the specific offer data entry to the consumer 102 includes transmitting the generated machine-readable code 320 to the consumer 102.

### Computer System Architecture

FIG. 9 illustrates a computer system 900 in which embodiments of the present disclosure, or portions thereof, may be implemented as computer-readable code. For example, the point of sale 110 or the offer provider 108 of FIG. 1 may be implemented in the computer system 900 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-8.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 918, a removable storage unit 922, and a hard disk installed in hard disk drive 912.

Various embodiments of the present disclosure are described in terms of this example computer system 900. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor 904 may be a special purpose or a general purpose processor device. The processor 904 may be connected to a communications infrastructure 906, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 900 may also include a main memory 908 (e.g., random access memory, read-only memory, etc.), and may also include a secondary memory 910. The secondary memory 910 may include the hard disk drive 912 and a removable storage drive 914, such as a floppy disk drive, a magnetic tape drive, an optical disk drive, a flash memory, etc.

The removable storage drive 914 may read from and/or write to the removable storage unit 918 in a well-known manner. The removable storage unit 918 may include a removable storage media that may be read by and written to by the removable storage drive 914. For example, if the removable storage drive 914 is a floppy disk drive, the removable storage unit 918 may be a floppy disk. In one embodiment, the removable storage unit 918 may be non-transitory computer readable recording media.

In some embodiments, the secondary memory 910 may include alternative means for allowing computer programs or other instructions to be loaded into the computer system 900, for example, the removable storage unit 922 and an interface 920. Examples of such means may include a program cartridge and cartridge interface (e.g., as found in video game systems), a removable memory chip (e.g., EEPROM, PROM, etc.) and associated socket, and other removable storage units 922 and interfaces 920 as will be apparent to persons having skill in the relevant art.

Data stored in the computer system 900 (e.g., in the main memory 908 and/or the secondary memory 910) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 900 may also include a communications interface 924. The communications interface 924 may be configured to allow software and data to be transferred between the computer system 900 and external devices. Exemplary communications interfaces 924 may include a modem, a network interface (e.g., an Ethernet card), a communications port, a PCMCIA slot and card, etc. Software and data transferred via the communications interface 924 may be in the form of signals, which may be electronic, electromagnetic, optical, or other signals as will be apparent to persons having skill in the relevant art. The signals may travel via a communications path 926, which may be configured to carry the signals and may be implemented using wire, cable, fiber optics, a phone line, a cellular phone link, a radio frequency link, etc.

Computer program medium and computer usable medium may refer to memories, such as the main memory 908 and secondary memory 910, which may be memory semiconductors (e.g., DRAMs, etc.). These computer program products may be means for providing software to the computer system 900. Computer programs (e.g., computer control logic) may be stored in the main memory 908 and/or the secondary memory 910. Computer programs may also be received via the communications interface 924. Such computer programs, when executed, may enable computer system 900 to implement the present methods as discussed herein. In particular, the computer programs, when executed, may enable processor device 904 to implement the methods illustrated by FIGS. 3-8, as discussed herein. Accordingly, such computer programs may represent controllers of the computer system 900. Where the present disclosure is implemented using software, the software may be stored in a computer program product and loaded into the computer system 900 using the removable storage drive 914, interface 920, and hard disk drive 912, or communications interface 924.

Techniques consistent with the present disclosure provide, among other features, systems and methods for discounting a payment transaction and distributing offer data. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for discounting a payment transaction, comprising:
storing, in a memory, transaction data for a payment transaction, wherein the transaction data includes at least a transaction amount;
receiving, by a receiving device, payment data submitted for payment for the payment transaction, wherein the payment data includes at least a consumer identifier corresponding to a consumer and payment information;
receiving, by the receiving device, offer data, wherein the offer data includes an offer identifier corresponding to the consumer and a transaction modifier;
encrypting, using a predetermined encryption key, the consumer identifier to obtain an encrypted consumer identifier; and
updating, in the memory, the transaction amount included in the transaction data based on the transaction modifier if the encrypted consumer identifier corresponds to the offer identifier.

2. The method of claim 1, wherein
receiving the payment data includes reading, by a first reading device, card data encoded on a payment card, and decoding, by a processing device, the read card data to obtain the payment data, and
receiving the offer data includes reading, by a second reading device, encoded offer data encoded in a machine-readable code, and decoding, by the processing device, the read encoded offer data to obtain the offer data.

3. The method of claim 2, wherein the first reading device and the second reading device are a single device.

4. The method of claim 1, further comprising:
transmitting, by a transmitting device, at least the transaction data and the payment information to an acquirer for use in processing the payment transaction.

5. The method of claim 1, further comprising:
generating, by a processing device, an authorization request for the payment transaction, wherein the authorization request includes at least the transaction data and the payment information; and
transmitting, by a transmitting device, the authorization request to a payment network.

6. The method of claim 1, wherein the consumer identifier is at least one of: name, e-mail address, phone number, and physical address.

7. The method of claim 1, wherein the transaction data further includes at least one of: transaction time and/or date, merchant name, merchant category, device identifier, merchant identifier, and product data.

8. The method of claim 1, wherein the offer data further includes at least one of: offer name, offer description, offer type, manufacturer data, merchant data, product data, start date, expiration date, quantity, and limitation on redemption.

9. The method of claim 1, further comprising:
encrypting, using one of: the predetermined encryption key or a second key corresponding to the predetermined encryption key, the offer identifier to obtain an encrypted offer identifier; wherein
the updating step is performed if the encrypted consumer identifier corresponds to the encrypted offer identifier.

10. The method of claim 1, wherein the offer identifier is an encrypted identifier.

11. A method for distributing offer data, comprising:
storing, in a database, a plurality of offer data entries, wherein each offer data entry includes data related to an offer for the purchase of goods or services including at least offer data and a transaction modifier;
receiving, by a receiving device, a consumer identifier associated with a consumer;
encrypting, using a predetermined encryption key, the received consumer identifier to obtain an encrypted identifier;
identifying, in the database, a specific offer data entry; and
transmitting, by a transmitting device, at least the encrypted identifier and the offer data and transaction modifier included in the specific offer data entry to the consumer.

12. The method of claim 11, further comprising:
generating, by a processing device, a machine-readable code encoded with at least the encrypted identifier and the offer data and transaction modifier included in the specific offer data entry, wherein
transmitting at least the encrypted identifier and the offer data and transaction modifier included in the specific offer data entry to the consumer includes transmitting the generated machine-readable code to the consumer.

13. The method of claim 11, wherein the consumer identifier is at least one of: name, e-mail address, phone number, and physical address.

14. The method of claim 11, wherein the offer data further includes at least one of: offer name, offer description, offer type, manufacturer data, merchant data, product data, start date, expiration date, quantity, and limitation on redemption.

15. A system for discounting a payment transaction, comprising:
a memory configured to store transaction data for a payment transaction, wherein the transaction data includes at least a transaction amount;
a receiving device configured to
receive payment data submitted for payment for the payment transaction, wherein the payment data includes at least a consumer identifier corresponding to a consumer and payment information, and
receive offer data, wherein the offer data includes an offer identifier corresponding to the consumer and a transaction modifier; and
a processing device configured to
encrypt, using a predetermined encryption key, the consumer identifier to obtain an encrypted consumer identifier, and
update, in the memory, the transaction amount included in the transaction data based on the transaction modifier if the encrypted consumer identifier corresponds to the offer identifier.

16. The system of claim 15, further comprising:
a first reading device configured to read card data encoded on a payment card; and
a second reading device configured to read encoded offer data encoded in a machine-readable code, wherein
receiving the payment data includes decoding, by the processing device, the read card data to obtain the payment data, and
receiving the offer data includes decoding, by the processing device, the read encoded offer data to obtain the offer data.

17. The system of claim 15, further comprising:
a transmitting device configured to at least the transaction data and the payment information to an acquirer for use in processing the payment transaction.

18. The system of claim 15, further comprising:
a transmitting device, wherein
the processing device is further configured to generate an authorization request for the payment transaction, wherein the authorization request includes at least the transaction data and the payment information, and
the transmitting device is configured to transmit the authorization request to a payment network.

19. The system of claim 15, wherein the consumer identifier is at least one of: name, e-mail address, phone number, and physical address.

20. The system of claim 15, wherein the transaction data further includes at least one of: transaction time and/or date, merchant name, merchant category, device identifier, merchant identifier, and product data.

21. The system of claim 15, wherein the offer data further includes at least one of: offer name, offer description, offer type, manufacturer data, merchant data, product data, start date, expiration date, quantity, and limitation on redemption.

22. The system of claim 15, wherein
the processing device is further configured to encrypt, using one of: the predetermined encryption key or a second key corresponding to the predetermined encryption key, the offer identifier to obtain an encrypted offer identifier, and
the processing device is configured to perform the updating step if the encrypted consumer identifier corresponds to the encrypted offer identifier.

23. The system of claim 15, wherein the offer identifier is an encrypted identifier.

24. A system for distributing offer data, comprising:
a database configured to store a plurality of offer data entries, wherein each offer data entry includes data related to an offer for the purchase of goods or services including at least offer data and a transaction modifier;
a receiving device configured to receive a consumer identifier associated with a consumer;
a processing device configured to
encrypt, using a predetermined encryption key, the received consumer identifier to obtain an encrypted identifier, and
identify, in the database, a specific offer data entry; and
a transmitting device configured to transmit at least the encrypted identifier and the offer data and transaction modifier included in the specific offer data entry to the consumer.

25. The system of claim 24, wherein:
the processing device is further configured to generate a machine-readable code encoded with at least the encrypted identifier and the offer data and transaction modifier included in the specific offer data entry, and
transmitting at least the encrypted identifier and the offer data and transaction modifier included in the specific offer data entry to the consumer includes transmitting the generated machine-readable code to the consumer.

26. The system of claim 24, wherein the consumer identifier is at least one of: name, e-mail address, phone number, and physical address.

27. The system of claim 24, wherein the offer data further includes at least one of: offer name, offer description, offer type, manufacturer data, merchant data, product data, start date, expiration date, quantity, and limitation on redemption.
